(19) United States
(12) Patent Application Publication
(10) Pub. No.: US 2006/0171527 A1
(43) Pub. Date: Aug. 3, 2006

(54) Switched supply coupling for driver

(76) Inventors: Michael J. Mills, Austin, TX (US); Long V. Nguyen, Austin, TX (US)

Correspondence Address: DAVIS & ASSOCIATES, P.O. BOX 1093, DRIPPING SPRINGS, TX, 78620, US

(21) Appl. No.: 11/027,704

(22) Filed: Dec. 30, 2004

(51) Int. Cl. H04M 1/00

(52) U.S. Cl. 379/395.01

(57) ABSTRACT

A driver is operated to drive signals from an integrated circuit. Operating the driver generates interference at substantially a first frequency that may interfere with circuitry sharing a power supply with the driver. A supply node is repeatedly coupled to and decoupled from the driver at substantially a second frequency higher than the first frequency to help supply power to the driver and to help prevent interference from propagating to circuitry sharing the power supply.

### BACKGROUND

Subscriber line (or loop) interface circuitry (SLIC) may be found in or near a central office exchange of a telecommunications network.

One SLIC provides a communications interface between a digital switching network for a central office exchange and an analog subscriber line. The analog subscriber line connects to subscriber equipment, such as a subscriber station or telephonic instrument for example, at a location remote from the central office exchange. The analog subscriber line and subscriber equipment form a subscriber loop.

The SLIC detects and transforms voiceband communications transmitted from the subscriber equipment in the form of low voltage analog signals on the subscriber loop into corresponding digital data for transmission to the digital switching network. For bi-directional communication, the SLIC also transforms digital data received from the digital switching network into corresponding low voltage analog signals for transmission on the subscriber loop to the subscriber equipment.

The SLIC typically uses different power supply levels depending on its operation state. The SLIC may use, for example, one supply level when the subscriber equipment is deactivated or on-hook, another supply level when the subscriber equipment is activated or off-hook, and yet another supply level to signal or ring the subscriber equipment for call progress.

One low-voltage integrated circuit for a SLIC has a closed-loop pulse width modulation (PWM) controller to control a direct-current to direct-current (DC-DC) converter to supply power to a high-voltage linefeed interface integrated circuit for the SLIC at different voltage levels. The SLIC may then help reduce or minimize any excess power by helping to control the DC-DC converter to change the voltage supply level supplied to the SLIC as the SLIC changes its power usage.

The PWM controller drives a PWM control signal to the DC-DC converter at a frequency in the frequency band used for digital subscriber line (DSL) communications. When the SLIC shares a low-voltage power supply with DSL circuitry, the driving of PWM control signals generates interference in the common connection to the low-voltage power supply and can therefore impact DSL communications. Such interference may also impact other circuitry on the low-voltage integrated circuit for the SLIC. Driving PWM control signals at a frequency above the DSL frequency band may help reduce this impact. Designing a DC-DC converter to operate at such a high frequency, however, is expensive and difficult.

### SUMMARY

One or more disclosed methods comprise operating a driver to drive signals from an integrated circuit, wherein operating the driver generates interference at substantially a first frequency that may interfere with circuitry sharing a power supply with the driver, and repeatedly coupling a supply node to and decoupling the supply node from the driver at substantially a second frequency higher than the first frequency to help supply power to the driver and to help prevent interference from propagating to circuitry sharing the power supply.

One or more disclosed integrated circuits comprise signal generation circuitry to generate and output signals at substantially a first frequency, a driver to drive signals from the integrated circuit in response to the signals output from the signal generation circuitry, wherein the driver generates interference that may interfere with circuitry sharing a power supply with the driver, and switched supply coupling circuitry to couple a supply node to and decouple the supply node from the driver repeatedly at substantially a second frequency higher than the first frequency to help supply power to the driver and to help prevent interference from propagating to circuitry sharing the power supply.

One or more disclosed systems comprise circuitry coupled to receive power from a power supply and an integrated circuit coupled to receive power from the power supply. The integrated circuit comprises signal generation circuitry to generate and output signals at substantially a first frequency, a driver to drive signals from the integrated circuit in response to the signals output from the signal generation circuitry, wherein the driver generates interference that may interfere with circuitry sharing the power supply, and switched supply coupling circuitry to couple a supply node to and decouple the supply node from the driver repeatedly at substantially a second frequency higher than the first frequency to help supply power to the driver and to help prevent interference from propagating to circuitry sharing the power supply.

### BRIEF DESCRIPTION OF THE DRAWINGS

One or more described embodiments are illustrated by way of example and not limitation in the figures of the accompanying drawings, in which like references indicate similar elements and in which:

FIG. 1 illustrates, for one or more embodiments, a system comprising circuitry sharing a power supply with an integrated circuit having switched supply coupling for a driver;

FIG. 2 illustrates, for one or more embodiments, a flow diagram for switched supply coupling for a driver;

FIG. 3 illustrates, for one or more embodiments, circuitry for switched supply coupling for a driver;

FIG. 4 illustrates, for one or more embodiments, circuitry for switched supply coupling for a driver;

FIG. 5 illustrates, for one or more embodiments, circuitry to generate a default logical low control signal;

FIG. 6 illustrates, for one or more embodiments, circuitry to generate a default logical high control signal; and

FIG. 7 illustrates, for one or more embodiments, a system comprising digital subscriber line (DSL) circuitry sharing a power supply with a subscriber line interface circuitry (SLIC) integrated circuit having switched supply coupling for a power supply controller control signal driver.

### DETAILED DESCRIPTION

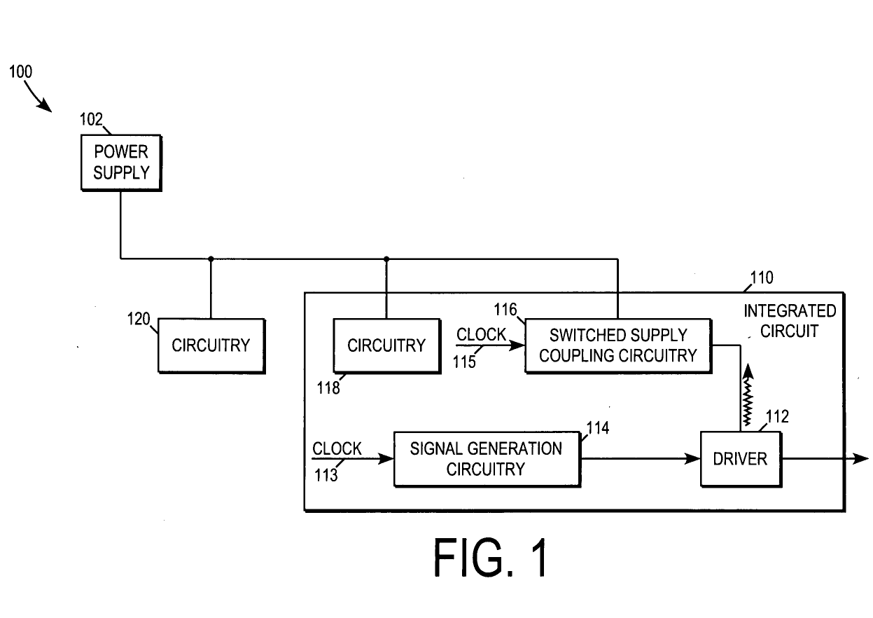

FIG. 1 illustrates, for one or more embodiments, a system 100 comprising an integrated circuit 110 sharing a power supply 102 with circuitry 120. Integrated circuit 110 and circuitry 120 may comprise any suitable circuitry to perform any suitable one or more functions. Integrated circuit 110 provides switched supply coupling for a driver 112 to help supply power to driver 112 and to help prevent interference from propagating to circuitry 118 on integrated circuit 110 and/or circuitry 120 from driver 112 through a common node coupled to power supply 102.

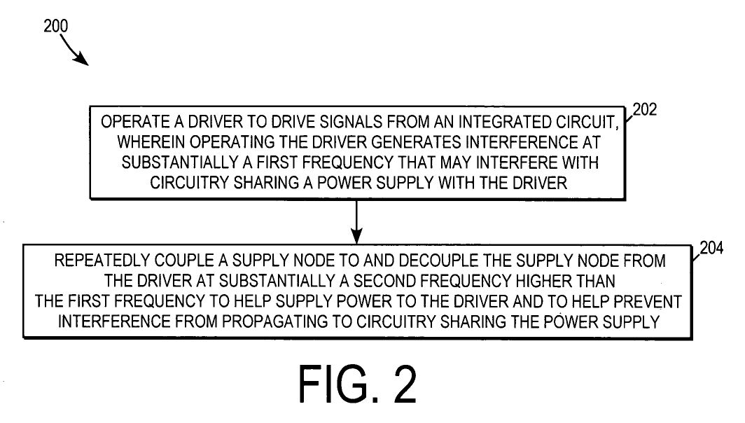

Integrated circuit 110 for one or more embodiments may provide switched supply coupling for driver 112 in accordance with a flow diagram 200 of FIG. 2.

For block 202 of FIG. 2, integrated circuit 110 operates driver 112 to drive signals from integrated circuit 110. Operating driver 112 generates interference at substantially a frequency that may interfere with circuitry 118 on integrated circuit 110 and/or circuitry 120. Integrated circuit 110 for one or more embodiments may operate driver 112 to drive signals from integrated circuit 110 at substantially a frequency in a predetermined frequency band in which circuitry 118 and/or circuitry 120 operate.

Integrated circuit 110 for one or more embodiments, as illustrated in FIG. 1, may comprise signal generation circuitry 114 to generate and output signals at substantially a frequency f₁. Driver 112 may be coupled to drive signals from integrated circuit 110 in response to the signals output from signal generation circuitry 114.

Signal generation circuitry 114 may comprise any suitable circuitry to generate and output any suitable signals in any suitable manner for any suitable purpose. Signal generation circuitry 114 for one or more embodiments may generate and output pulse width modulated (PWM) signals to control, for example, another power supply. Signal generation circuitry 114 for one or more embodiments may generate and output delta-sigma modulated signals to control, for example, another power supply.

Driver 112 may comprise any suitable circuitry to drive signals from integrated circuit 110 over any suitable transmission medium in response to signals output from signal generation circuitry 114.

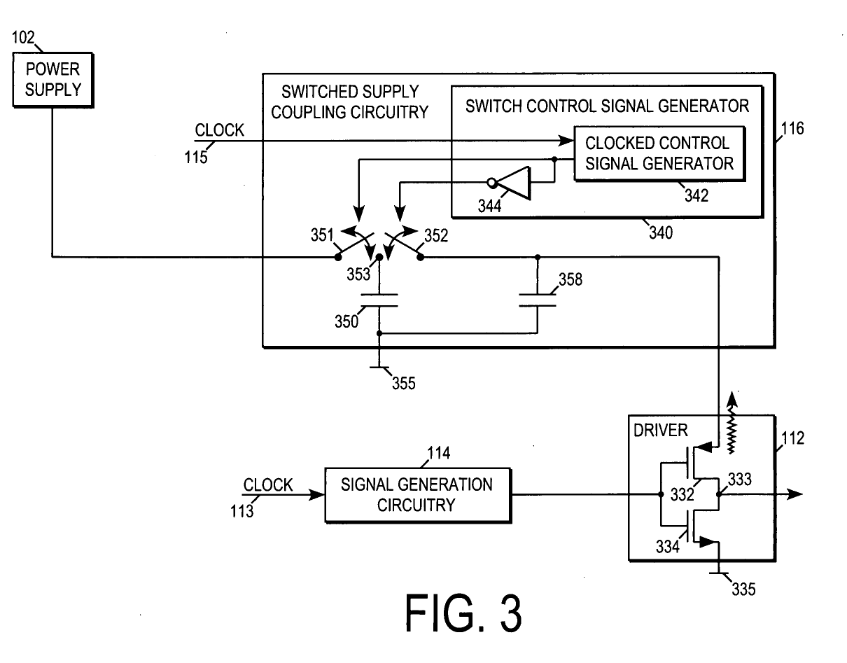

Driver 112 for one or more embodiments, as illustrated in FIG. 3, may comprise a p-channel field effect transistor (p-FET) 332 coupled between switched supply coupling circuitry 116 and a signal output node 333 and comprise an n-channel FET (n-FET) 334 coupled between signal output node 333 and a reference supply node 335, such as a ground supply node for example. Both p-FET 332 and n-FET 334 may have a gate coupled to receive signals from signal generation circuitry 114.

In response to a logical high signal from signal generation circuitry 114, p-FET 332 may be deactivated and n-FET 334 activated to pull output node 333 to reference supply node 335 to output a logical low signal from integrated circuit 10, thereby driving the logical high signal as an inverted signal from integrated circuit 110. In response to a logical low signal from signal generation circuitry 114, n-FET 334 may be deactivated and p-FET 332 activated to pull output node 333 to switched supply coupling circuitry 116 to output a logical high signal from integrated circuit 110, thereby driving the logical low signal as an inverted signal from integrated circuit 110. As p-FET 332 and n-FET 334 switch output node 333 back and forth between switched supply coupling circuitry 116 and reference supply node 335, interference may be generated from driver 112 at substantially the frequency at which driver 112 drives signals.

Circuitry 118 and/or circuitry 120 for one or more embodiments may operate at substantially frequency f₁ in any suitable manner for any suitable purpose. Circuitry 120, for example, may transmit and/or receive signals at substantially frequency f₁. Circuitry 118 and/or circuitry 120 for one or more embodiments may operate in any suitable manner for any suitable purpose in a predetermined frequency band containing frequency f₁.

For block 204 of FIG. 2, integrated circuit 110 repeatedly couples a supply node to and decouples the supply node from driver 112 at substantially a frequency higher than the frequency at which driver 112 drives signals to help supply power to driver 112 and to help prevent interference from propagating to circuitry 118 on integrated circuit 110 and/or circuitry 120. For one or more embodiments where circuitry 118 and/or circuitry 120 operate in a predetermined frequency band, integrated circuit 110 for one or more embodiments may repeatedly couple a supply node to and decouple the supply node from driver 112 at substantially a frequency higher than the predetermined frequency band.

Integrated circuit 110 for one or more embodiments, as illustrated in FIG. 1, may comprise switched supply coupling circuitry 116. Switched supply coupling circuitry 116 may comprise any suitable circuitry coupled to power supply 102 and to driver 112 to repeatedly couple a supply node to and decouple the supply node from driver 112 at substantially a frequency higher than the frequency at which driver 112 drives signals. Switched supply coupling circuitry 116 for one or more embodiments may then help supply power to driver 112 while helping to prevent interference generated by driver 112 from propagating to circuitry 118 and/or circuitry 120 through a common node coupled to power supply 102.

Switched supply coupling circuitry 116 for one or more embodiments may comprise any suitable circuitry to help store any suitable amount of energy from power supply 102 while the supply node is decoupled from driver 112 and may then help supply any suitable amount of stored energy to driver 112 while the supply node is coupled to driver 112. Switched supply coupling circuitry 116 for one or more embodiments may comprise, for example, one or more capacitors and/or one or more inductors. Switched supply coupling circuitry 116 for one or more embodiments may then repeatedly couple power supply 102 to one or more capacitors and/or one or more inductors to store energy and couple such capacitor(s) and/or inductor(s) to driver 112 to supply energy from such capacitor(s) and/or inductor(s) to driver 112. Switched supply coupling circuitry 116 for one or more embodiments may be coupled to one or more capacitors and/or one or more inductors external to integrated circuit 110 to help store and/or supply energy to driver 112.

Switched supply coupling circuitry 116 for one or more embodiments may comprise any suitable circuitry to generate at the supply node a voltage level less than, approximately equal to, or greater than that supplied by power supply 102.

Signal generation circuitry 114 for one or more embodiments may be coupled to be driven by a clock signal 113, and switched supply coupling circuitry 116 for one or more embodiments may be coupled to be driven by a clock signal 115. Switched supply coupling circuitry 116 for one or more embodiments may comprise any suitable circuitry to halt supplying power to driver 112 if clock signal 115 stops. For one or more embodiments where clock signal 115 is derived from the same clock source used to derive clock signal 113, switched supply coupling circuitry 116 may therefore help provide a failsafe mechanism to help prevent driver 112 from driving signals in the event, for example, the clock source becomes disabled. The clock source for one or more embodiments may be on integrated circuit 110. The clock source for one or more embodiments may be external to integrated circuit 110.

Switched supply coupling circuitry 116 for one or more embodiments may comprise any suitable charge pump circuit. Switched supply coupling circuitry 116 for one or more embodiments may comprise any suitable switching regulator circuit.

### EXAMPLE SWITCHED CAPACITOR CIRCUIT

Switched supply coupling circuitry 116 for one or more embodiments, as illustrated in FIG. 3, may comprise a switch control signal generator 340 and a switched capacitor circuit comprising a capacitor 350 coupled between a supply node 353 and a reference supply node 355, such as a ground supply node for example, a reservoir capacitor 358 coupled between driver 112 and reference supply node 355, a first switch 351 coupled to couple power supply 102 to supply node 353 in response to a first control signal from switch control signal generator 340, and a second switch 352 coupled to couple supply node 353 to driver 112 in response to a second control signal from switch control signal generator 340. First switch 351 and second switch 352 may be implemented using any suitable circuitry, such as field effect transistors (FETs), bipolar junction transistors (BJTs), and/or diodes for example. Although described as part of the switched capacitor circuit on integrated circuit 110, one or more components of the switched capacitor circuit, such as capacitor 350 and/or capacitor 358 for example, may be external to integrated circuit 110.

Switch control signal generator 340 may comprise any suitable circuitry to generate first and second control signals for first and second switches 351 and 352, respectively, in any suitable manner.

Switch control signal generator 340 for one or more embodiments may comprise a clocked control signal generator 342 to generate a clocked control signal having substantially a frequency higher than the frequency at which driver 112 drives signals and having any suitable duty cycle. Switch control signal generator 340 for one or more embodiments may be coupled to be driven by clock signal 115. Switch control signal generator 340 for one or more embodiments may comprise any suitable circuitry to derive from clock signal 115 the clocked control signal at any suitable frequency.

First switch 351 for one or more embodiments may be coupled to receive the clocked control signal to couple power supply 102 to supply node 353 to help store energy by charging capacitor 350 in response to a first phase of the clocked control signal and to decouple power supply 102 from supply node 353 in response to a second phase of the clocked control signal. Second switch 352 for one or more embodiments may be coupled to receive the clocked control signal through an inverter 344 to couple supply node 353 to driver 112 to supply stored energy to driver 112 by discharging capacitor 350 and charging reservoir capacitor 358 in response to the second phase of the clocked control signal and to decouple supply node 353 from driver 112 in response to the first phase of the clocked control signal.

As switch control signal generator 340 alternately activates switches 351 and 352 repeatedly, the switched capacitor circuit therefore transfers energy from power supply 102 to driver 112. If switch control signal generator 340 stops generating the clocked control signal, for example because clock signal 115 stops, the switched capacitor circuit of FIG. 3 halts supplying power to driver 112. For one or more embodiments where clock signal 115 is derived from the same clock source used to derive clock signal 113, switch control signal generator 340 and the switched capacitor circuit of FIG. 3 may therefore help provide a failsafe mechanism to help prevent driver 112 from driving signals in the event, for example, the clock source becomes disabled.

### EXAMPLE VOLTAGE DOUBLER CIRCUIT

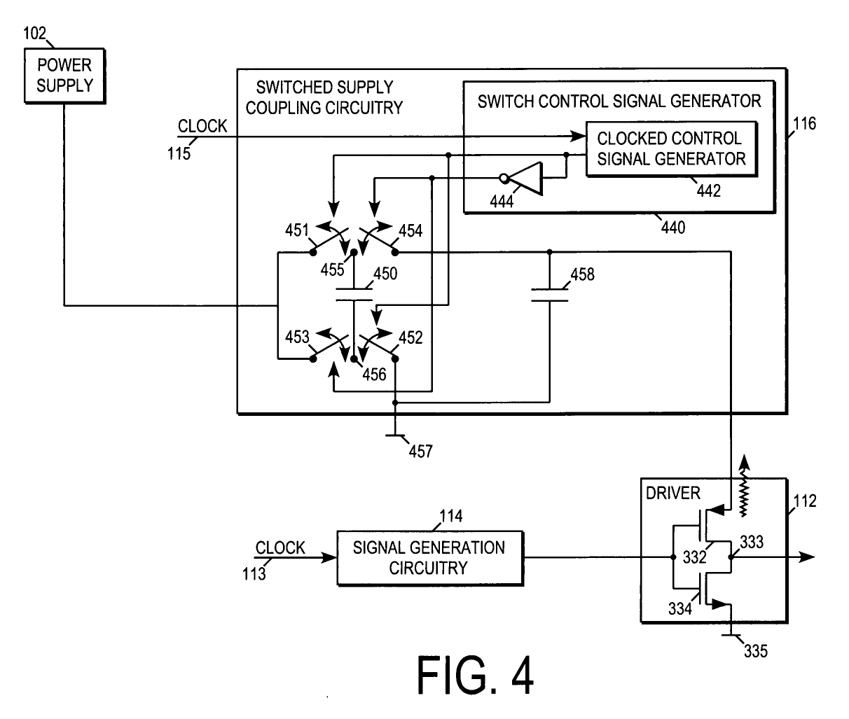

Switched supply coupling circuitry 116 for one or more embodiments, as illustrated in FIG. 4, may comprise a switch control signal generator 440 and a voltage doubler circuit comprising a capacitor 450 coupled between a supply node 455 and another node 456, a reservoir capacitor 458 coupled between driver 112 and a reference supply node 457, such as a ground supply node for example, a first switch 451 coupled to couple power supply 102 to supply node 455 in response to a first control signal from switch control signal generator 440, a second switch 452 coupled to couple node 456 to reference supply node 457 in response to the first control signal from switch control signal generator 440, a third switch 453 coupled to couple power supply 102 to node 456 in response to a second control signal from switch control signal generator 440, and a fourth switch 454 coupled to couple supply node 455 to driver 112 in response to the second control signal from switch control signal generator 440. Switches 451-454 may be implemented using any suitable circuitry, such as field effect transistors (FETs), bipolar junction transistors (BJTs), and/or diodes for example. Although described as part of the voltage doubler circuit on integrated circuit 110, one or more components of the voltage doubler circuit, such as capacitor 450 and/or capacitor 458 for example, may be external to integrated circuit 110.

Switch control signal generator 440 may comprise any suitable circuitry to generate in any suitable manner a first control signal for switches 451-452 and a second control signal for switches 453-454.

Switch control signal generator 440 for one or more embodiments may comprise a clocked control signal generator 442 to generate a clocked control signal having substantially a frequency higher than the frequency at which driver 112 drives signals and having any suitable duty cycle. Switch control signal generator 440 for one or more embodiments may be coupled to be driven by clock signal 115. Switch control signal generator 440 for one or more embodiments may comprise any suitable circuitry to derive from clock signal 115 the clocked control signal at any suitable frequency.

First and second switches 451 and 452 for one or more embodiments may be coupled to receive the clocked control signal to couple capacitor 450 between power supply 102 and reference supply node 457 to help store energy by charging capacitor 450 in response to a first phase of the clocked control signal and to decouple capacitor 450 from between power supply 102 and reference supply node 457 in response to a second phase of the clocked control signal. Third and fourth switches 453 and 454 for one or more embodiments may be coupled to receive the clocked control signal through an inverter 444 to couple capacitor 450 between power supply 102 and driver 112 to charge reservoir capacitor 458 and generate at supply node 455, and therefore supply to driver 112, an approximately doubled voltage level relative to the voltage level supplied by power supply 102 in response to the second phase of the clocked control signal and to decouple capacitor 450 from between power supply 102 and driver 112 in response to the first phase of the clocked control signal.

As switch control signal generator 440 alternately activates switch pairs 451-452 and 453-454 repeatedly, the voltage doubler circuit therefore transfers energy from power supply 102 to driver 112. If switch control signal generator 440 stops generating the clocked control signal, for example because clock signal 115 stops, the voltage doubler circuit of FIG. 4 halts supplying power to driver 112. For one or more embodiments where clock signal 115 is derived from the same clock source used to derive clock signal 113, switch control signal generator 440 and the voltage doubler circuit of FIG. 4 may therefore help provide a failsafe mechanism to help prevent driver 112 from driving signals in the event, for example, the clock source becomes disabled.

### FAILSAFE MECHANISM

As described in connection with FIGS. 1, 3, and 4, switched supply coupling circuitry 116 for one or more embodiments may halt supplying power to driver 112 if clock signal 115 stops. For one or more embodiments where clock signal 115 is derived from the same clock source used to derive clock signal 113, switched supply coupling circuitry 116 may therefore help provide a failsafe mechanism to help prevent driver 112 from driving signals in the event, for example, the clock source becomes disabled. For one or more embodiments where driver 112 drives signals to control other circuitry, this failsafe mechanism may be used to help deactivate such other circuitry if the clock source stops.

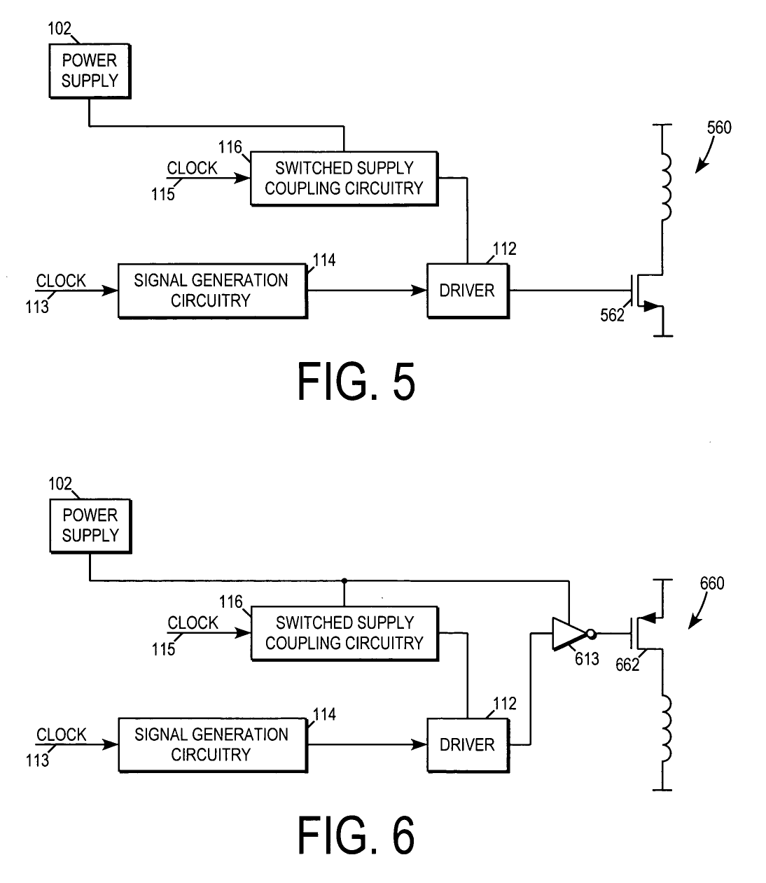

As illustrated in FIG. 5, signal generation circuitry 114 for one or more embodiments may generate and output signals to driver 112 to drive control signals to activate and deactivate a pull-down n-channel field effect transistor (n-FET) 562 of circuitry 560 and therefore control the activation and deactivation of circuitry 560. Circuitry 560 may or may not be powered by the same power supply 102 supplying integrated circuit 110. Driving a logical high signal activates pull-down n-FET 562 and therefore activates circuitry 560, and driving a logical low signal deactivates pull-down n-FET 562 and therefore deactivates circuitry 560. Because driver 112 would drive a logical low signal if clock signal 115 stops and switched supply coupling circuitry 116 halts supplying power to driver 112, circuitry 560 would be deactivated if clock signal 115 stops.

As illustrated in FIG. 6, signal generation circuitry 114 for one or more embodiments may generate and output signals to driver 112 to drive control signals through an inverter 613 to activate and deactivate a pull-up p-channel field effect transistor (p-FET) 662 of circuitry 660 and therefore control the activation and deactivation of circuitry 660. Circuitry 660 may or may not be powered by the same power supply supplying integrated circuit 110. Driving a logical high signal generates a logical low signal from inverter 613 and activates pull-up p-FET 662 and therefore activates circuitry 660, and driving a logical low signal generates a logical high signal from inverter 613 and deactivates pull-up p-FET 662 and therefore deactivates circuitry 560. Because driver 112 would drive a logical low signal if clock signal 115 stops and switched supply coupling circuitry 116 halts supplying power to driver 112, circuitry 660 would be deactivated if clock signal 115 stops.

Inverter 613 may or may not be powered by the same power supply supplying integrated circuit 110. Inverter 613 for one or more embodiments may be on integrated circuit 110 and powered by power supply 102 as illustrated in FIG. 6.

### EXAMPLE SYSTEM

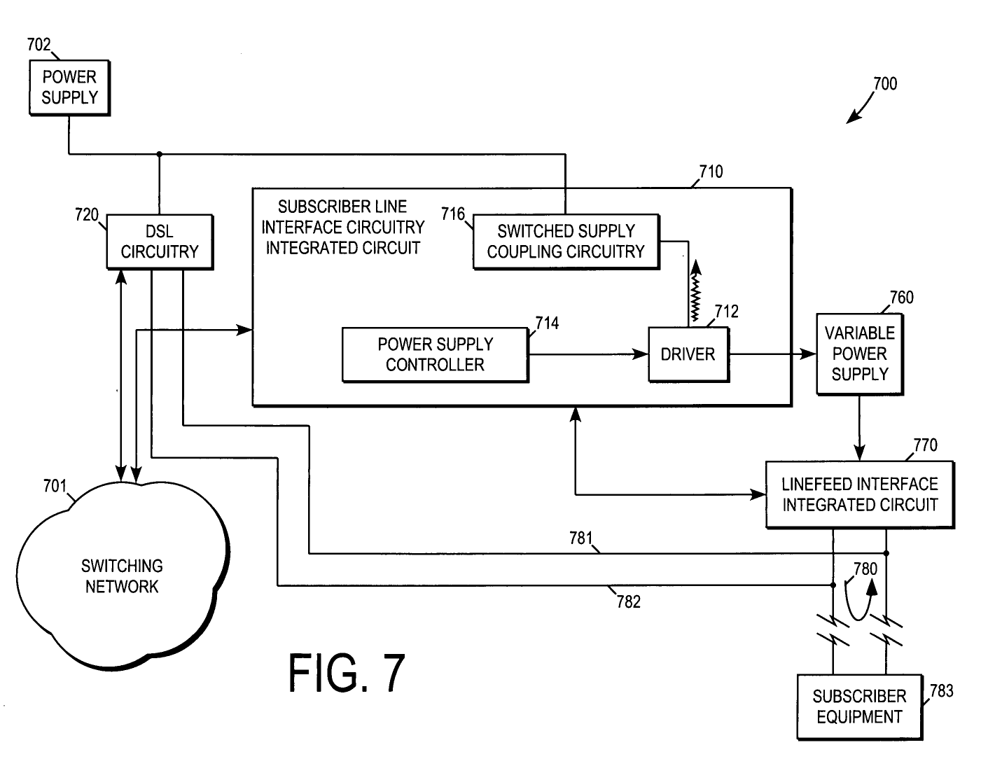

FIG. 7 illustrates, for one or more embodiments, a system 700 comprising digital subscriber line (DSL) circuitry 720 sharing a power supply 702 with a subscriber line interface circuitry (SLIC) integrated circuit 710 comprising switched supply coupling circuitry 716 to provide switched supply coupling for a driver 712 that drives control signals from a power supply controller 714 from SLIC integrated circuit 710. Power supply 702, SLIC integrated circuit 710, driver 712, power supply controller 714, switched supply coupling circuitry 716, and DSL circuitry 720 generally correspond to power supply 102, integrated circuit 110, driver 112, signal generation circuitry 114, switched supply coupling circuitry 116, and circuitry 120, respectively, of FIG. 1.

Driver 712 for one or more embodiments may drive control signals in response to control signals from power supply controller 714 to control a variable power supply 760 dynamically to supply power to a linefeed interface integrated circuit 770 at different supply levels. Power supply controller 714 for one or more embodiments may control variable power supply 760 to switch between or among different power supply levels based on, for example, the operation state of SLIC integrated circuit 710. Power supply controller 714 for one or more embodiments may generate and output pulse width modulated (PWM) signals to control a direct-current to direct-current (DC-DC) converter. Power supply controller 714 for one or more embodiments may generate and output delta-sigma modulated signals to control a direct-current to direct-current (DC-DC) converter. Although power supply 702 and variable power supply 760 are illustrated as separate power supplies, power supply 702 and variable power supply 760 for one or more embodiments may use a common power supply source.

SLIC integrated circuit 710 and linefeed interface integrated circuit 770 for one or more embodiments may provide a communications interface between a switching network 701 and a subscriber loop 780. Switching network 701 for one or more embodiments may be a digital switching network for a larger telecommunications network, such as the Public Switched Telephone Network (PSTN). SLIC integrated circuit 710 and linefeed interface integrated circuit 770 may be used for any suitable application such as, for example and without limitation, digital loop carriers; Central Office telephony; pair gain remote terminals; wireless local loop (WLL); digital subscriber line (DSL), coder/decoder (codec), and/or wireline or wireless voice-over-broadband systems; cable telephony; private branch exchange (PBX), Internet protocol PBX (IP-PBX), and/or key telephone systems; Integrated Services Digital Network (ISDN), Ethernet, and/or Universal Serial Bus (USB) terminal adapters; and/or Integrated Voice and Data (IVD) systems.

Subscriber loop 780 for one or more embodiments, as illustrated in FIG. 7, is defined by a first line 781, a second line 782, and subscriber equipment 783. For one or more embodiments where SLIC integrated circuit 710 and linefeed interface integrated circuit 770 provide an analog telephone interface, first line 781 is called a tip line and second line 782 is called a ring line. Subscriber equipment 783 is electrically coupled to first line 781 and second line 782 and may comprise any suitable number of one or more devices comprising any suitable circuitry to transmit and receive any suitable signals over first line 781 and second line 782 in any suitable manner. Subscriber equipment 783 for one or more embodiments may comprise any suitable customer premises equipment (CPE), such as an analog telephone and/or a digital subscriber line (DSL) modem for example.

SLIC integrated circuit 710 and linefeed interface integrated circuit 770 for one or more embodiments may be coupled to receive signals on subscriber loop 780 from subscriber equipment 783 and forward the received signals or transform and transmit the received signals to switching network 701. SLIC integrated circuit 710 and linefeed interface integrated circuit 770 for one or more embodiments may be coupled to receive signals from switching network 701 and forward the received signals or transform and transmit the received signals on subscriber loop 780 to subscriber equipment 783.

For one or more embodiments where SLIC integrated circuit 710 and linefeed interface integrated circuit 770 provide an analog telephone interface to subscriber loop 780 and where switching network 701 is a digital switching network, SLIC integrated circuit 710 and linefeed interface integrated circuit 770 may receive voiceband communications transmitted from subscriber equipment 783 in the form of low voltage analog signals on subscriber loop 780 and transform them into corresponding digital data signals for transmission to switching network 701. SLIC integrated circuit 710 and linefeed interface integrated circuit 770 for one or more embodiments may also transform digital data signals received from switching network 701 into corresponding low voltage analog signals for transmission on subscriber loop 780 to subscriber equipment 783.

SLIC integrated circuit 710 and linefeed interface integrated circuit 770 may transmit and receive signals over subscriber loop 780 at any suitable frequency in any suitable frequency band. SLIC integrated circuit 710 and linefeed interface integrated circuit 770 for one or more embodiments may transmit and receive signals over subscriber loop 780 in a frequency band ranging, for example, from approximately 300 Hertz (Hz) to approximately 3-4 kiloHertz (kHz).

SLIC integrated circuit 710 for one or more embodiments may be a relatively low voltage device and may comprise power supply controller 714 to help control relatively higher voltages to operate subscriber equipment 783. SLIC integrated circuit 710 and linefeed interface integrated circuit 770 for one or more embodiments may comprise any suitable circuitry to perform any suitable one or more BORSCHT functions and/or any other suitable one or more functions. BORSCHT is an acronym for battery feed, overvoltage protection, ring, supervision, coder/decoder (codec), hybrid, and test.

DSL circuitry 720 for one or more embodiments may also provide a communications interface between switching network 701 and subscriber loop 780 to support DSL communications over subscriber loop 780. DSL circuitry 720 for one or more embodiments may be coupled to receive signals on subscriber loop 780 from subscriber equipment 783, such as a DSL modem for example, and forward the received signals or transform and transmit the received signals to switching network 701. DSL circuitry 720 for one or more embodiments may be coupled to receive signals from switching network 701 and forward the received signals or transform and transmit the received signals on subscriber loop 780 to subscriber equipment 783.

DSL circuitry 720 may transmit and receive signals over subscriber loop 780 at any suitable frequency in any suitable frequency band. DSL circuitry 720 for one or more embodiments may receive DSL communications over subscriber loop 780 in a frequency band ranging, for example, from approximately 20-30 kiloHertz (kHz) to approximately 138-160 kHz and may transmit DSL communications over subscriber loop 780 in a frequency band ranging, for example, from approximately 150-240 kHz to approximately 1.1-1.5 MegaHertz (MHz).

Power supply controller 714 for one or more embodiments may generate and output signals to driver 712 at substantially any suitable frequency in the DSL communications frequency band in which DSL circuitry 720 operates, such as at substantially 250 kHz, 500 kHz, or 1 MHz for example. Because the resulting interference from driver 712 may interfere with DSL circuitry 720, switched supply coupling circuitry 716 may repeatedly couple a supply node to and decouple the supply node from driver 712 at substantially any suitable frequency higher than the DSL communications frequency band in which DSL circuitry 720 operates, such as at substantially 50 MHz or 128 MHz for example, to help supply power to driver 712 and to help prevent interference from propagating to DSL circuitry 720.

In the foregoing description, one or more embodiments of the present invention have been described. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
operating a driver to drive signals from an integrated circuit, wherein operating the driver generates interference at substantially a first frequency that may interfere with circuitry sharing a power supply with the driver; and
repeatedly coupling a supply node to and decoupling the supply node from the driver at substantially a second frequency higher than the first frequency to help supply power to the driver and to help prevent interference from propagating to circuitry sharing the power supply.

2. The method of claim 1, comprising:
storing energy from the power supply while the supply node is decoupled from the driver; and
supplying stored energy to the driver while the supply node is coupled to the driver.

3. The method of claim 2, wherein the storing energy comprises coupling the power supply to one or more capacitors.

4. The method of claim 1, comprising generating at the supply node an increased voltage level from the power supply.

5. The method of claim 1, wherein the operating comprises operating a driver in response to a first clock signal;
wherein the repeatedly coupling and decoupling comprises repeatedly coupling a supply node to and decoupling the supply node from the driver in response to a second clock signal derived from a same clock source as the first clock signal; and
wherein the method comprises halting the supply of power to the driver if the clock source stops.

6. The method of claim 1, wherein the operating a driver comprises operating the driver by subscriber line interface circuitry to drive signals to control a variable power supply for linefeed interface circuitry.

7. The method of claim 1, comprising operating circuitry sharing the power supply with the driver to support digital subscriber line (DSL) communications.

8. An integrated circuit comprising:
signal generation circuitry to generate and output signals at substantially a first frequency;
a driver to drive signals from the integrated circuit in response to the signals output from the signal generation circuitry, wherein the driver generates interference that may interfere with circuitry sharing a power supply with the driver; and
switched supply coupling circuitry to couple a supply node to and decouple the supply node from the driver repeatedly at substantially a second frequency higher than the first frequency to help supply power to the driver and to help prevent interference from propagating to circuitry sharing the power supply.

9. The integrated circuit of claim 8, wherein the switched supply coupling circuitry comprises circuitry to help store energy from the power supply while the supply node is decoupled from the driver and to help supply stored energy to the driver while the supply node is coupled to the driver.

10. The integrated circuit of claim 9, wherein the switched supply coupling circuitry comprises one or more capacitors to store energy.

11. The integrated circuit of claim 8, wherein the switched supply coupling circuitry comprises circuitry to generate at the supply node an increased voltage level from the power supply.

12. The integrated circuit of claim 8, wherein the signal generation circuitry is coupled to be driven by a first clock signal;
wherein the switched supply coupling circuitry is coupled to be driven by a second clock signal derived from a same clock source as the first clock signal; and
wherein the switched supply coupling circuitry comprises circuitry to halt supplying power to the driver if the clock source stops.

13. The integrated circuit of claim 8, wherein the integrated circuit comprises subscriber line interface circuitry and the driver is to drive signals to control a variable power supply for linefeed interface circuitry.

14. The integrated circuit of claim 8, wherein circuitry sharing the power supply with the driver is to support digital subscriber line (DSL) communications.

15. A system comprising:
(a) circuitry coupled to receive power from a power supply; and
(b) an integrated circuit coupled to receive power from the power supply, the integrated circuit comprising:
(i) signal generation circuitry to generate and output signals at substantially a first frequency,
(ii) a driver to drive signals from the integrated circuit in response to the signals output from the signal generation circuitry, wherein the driver generates interference that may interfere with circuitry sharing the power supply, and
(iii) switched supply coupling circuitry to couple a supply node to and decouple the supply node from the driver repeatedly at substantially a second frequency higher than the first frequency to help supply power to the driver and to help prevent interference from propagating to circuitry sharing the power supply.

16. The system of claim 15, wherein the switched supply coupling circuitry comprises circuitry to help store energy from the power supply while the supply node is decoupled from the driver and to help supply stored energy to the driver while the supply node is coupled to the driver.

17. The system of claim 16, wherein the switched supply coupling circuitry comprises one or more capacitors to store energy.

18. The system of claim 15, wherein the switched supply coupling circuitry comprises circuitry to generate at the supply node an increased voltage level from the power supply.

19. The system of claim 15, wherein the signal generation circuitry is coupled to be driven by a first clock signal;
wherein the switched supply coupling circuitry is coupled to be driven by a second clock signal derived from a same clock source as the first clock signal; and
wherein the switched supply coupling circuitry comprises circuitry to halt supplying power to the driver if the clock source stops.

20. The system of claim 15, wherein the integrated circuit comprises subscriber line interface circuitry and the driver is to drive signals to control a variable power supply for linefeed interface circuitry.

21. The system of claim 15, wherein circuitry sharing the power supply with the driver is to support digital subscriber line (DSL) communications.
